(19) United States
(12) Patent Application Publication
(10) Pub. No.: US 2014/0376217 A1
(43) Pub. Date: Dec. 25, 2014

(54) ILLUMINATION DEVICE

(71) Applicant: Enplas Corporation, Saitama (JP)

(72) Inventors: Kyouhei Yamada, Saitama (JP); Noriyuki Kawahara, Saitama (JP)

(21) Appl. No.: 14/372,463

(22) PCT Filed: Jan. 17, 2013
(86) PCT No.: PCT/JP2013/000173

§ 371 Date: Jul. 16, 2014

(30) Foreign Application Priority Data
Jan. 19, 2012 (JP) 2012-008902

(51) Int. Cl. F21K 99/00

(52) U.S. Cl. CPC F21K 9/17; F21Y 2103/003
USPC 362/217.02

(57) ABSTRACT

An illuminating apparatus (100) has: a light source unit (140), which includes a light emitting element (110), and a luminous flux control member (120); a columnar light guide rod (160), which is composed of a transparent material; and a cover (170), which is disposed to cover the light source unit (140) and the light guide rod (160), said cover being disposed with respect to the light source unit (140) and the light guide rod (160) with an air layer therebetween. The light source unit (140) is disposed such that an output surface (126) of the luminous flux control member (120) faces an end surface (162) of the light guide rod (160).

### TECHNICAL FIELD

The present invention relates to an illumination device which uses a light emitting element as a light source, and can be used in place of fluorescent tubes and the like.

### BACKGROUND ART

In recent years, in view of energy saving and environmental conservation, illumination devices (such as LED bulbs and LED fluorescent tubes) using a light-emitting diode (hereinafter also referred to as “LED”) as a light source have been increasingly used as an illumination device in place of electric light bulbs and fluorescent tubes. In generally used LED fluorescent tubes, a plurality of LEDs are linearly disposed on a substrate at a predetermined interval, and a cover is disposed so as to cover the LEDs. However, the conventional LED fluorescent tubes have a problem that bright spots corresponding to LEDs are seen through the cover, and the luminance unevenness is significant. It is conceivable to increase the number of LEDs or reduce the light transmittance of the cover in order to make the bright spots less noticeable; however, such solutions to the problem are not preferable in view of energy saving. In addition, the conventional LED fluorescent tubes have a problem that the light distribution angle is narrow (for example, 150°).

In order to solve the problems of the conventional LED fluorescent tubes, there has been proposed an illumination device in which an LED is disposed at an end portion of a light emission region (see, for example, PTL 1). FIG. 1 is a side view illustrating a configuration of the illumination device disclosed in PTL 1.

As illustrated in FIG. 1, illumination device 10 disclosed in PTL 1 includes LED 12 serving as a light source, round-columnar optical member 14 made of a transparent material, cylindrical cover 16 made of a light transmissive material, and handle part 18 made of a non-light transmissive material. LED 12 is disposed in such a manner that it faces an end surface of round columnar optical member 14. The outer peripheral surface of optical member 14 is roughened in order to provide a light expansion function. In handle part 18, LED 12, a driving section, a power source, and the like are housed.

In illumination device 10 disclosed in PTL 1, light emitted from LED 12 enters round columnar optical member 14 from an end surface of optical member 14. Part of the light having entered optical member 14 is output to the outside while being diffused at the outer peripheral surface of optical member 14. The light output from the outer peripheral surface of optical member 14 is transmitted through cover 16 and then output to the outside (see FIG. 1). In the case of illumination device 10 disclosed in PTL 1, LED 12 is disposed at the end portion of the light emission region, and therefore the bright spot corresponding to LED 12 is not seen through cover 16. In addition, since the light is output in all directions from outer peripheral surface of optical member 14, the light distribution angle is wide.

### CITATION LIST

### Patent Literature

PTL 1

Japanese Patent Application Laid-Open No. 2009-169157

### SUMMARY OF INVENTION

### Technical Problem

However, illumination device 10 disclosed in PTL 1 has a problem that the region around LED 12 cannot be used as effective light emission region 20. As illustrated in FIG. 1, in illumination device 10 disclosed in PTL 1, the region corresponding to cover 16 serves as effective light emission region 20, and the region corresponding to handle part 18 serves as non-light emission region 22. Thus the region around LED 12 cannot be used as effective light emission region 20. If LED 12 is covered by light transmissive cover 16, not by handle part 18, the luminance in the region around LED 12 becomes significantly high in comparison with the other regions, and thus luminance unevenness is caused. For this reason, in illumination device 10 disclosed in PTL 1, covering LED 12 by cover 16 is not realistic.

In addition, illumination device 10 disclosed in PTL 1 has another problem that luminance unevenness is caused in effective light emission region 20. As illustrated in FIG. 1, in illumination device 10 disclosed in PTL 1, the distribution of the light emitted from LED 12 is not controlled, and the light enters optical member 14 as it is. As a result, in illumination device 10 disclosed in PTL 1, the amount of light that reaches the opposite end portion of optical member 14 is insufficient, and the luminance is significantly different between the both ends of effective light emission region 20.

An object of the present invention is to provide an illumination device which includes a light emitting element, and can achieve both expansion of the effective light emission region and uniformization of the luminance in the effective light emission region.

### Solution to Problem

An illumination device of embodiments of the present invention includes: a light guiding member; a light source unit including a light emitting element and a light flux controlling member that controls a distribution of light emitted from the light emitting element, the light source unit being disposed in such a manner that light passed through the light flux controlling member is incident on an end surface of the light guiding member; and a cover disposed in such a manner as to cover at least part of the light source unit and the light guiding member, with an air layer interposed between the cover and at least part of the light source unit and between the cover and the light guiding member, wherein an exterior surface of the cover corresponding to at least part of the light source unit and the light guiding member serves as a light emission region.

### Advantageous Effects of Invention

According to the present invention, it is possible to provide an illumination device which can achieve both expansion of the effective light emission region and uniformization of the luminance in the effective light emission region.

### BRIEF DESCRIPTION OF DRAWINGS

FIG. 1 is a front view illustrating a configuration of an illumination device disclosed in PTL 1;

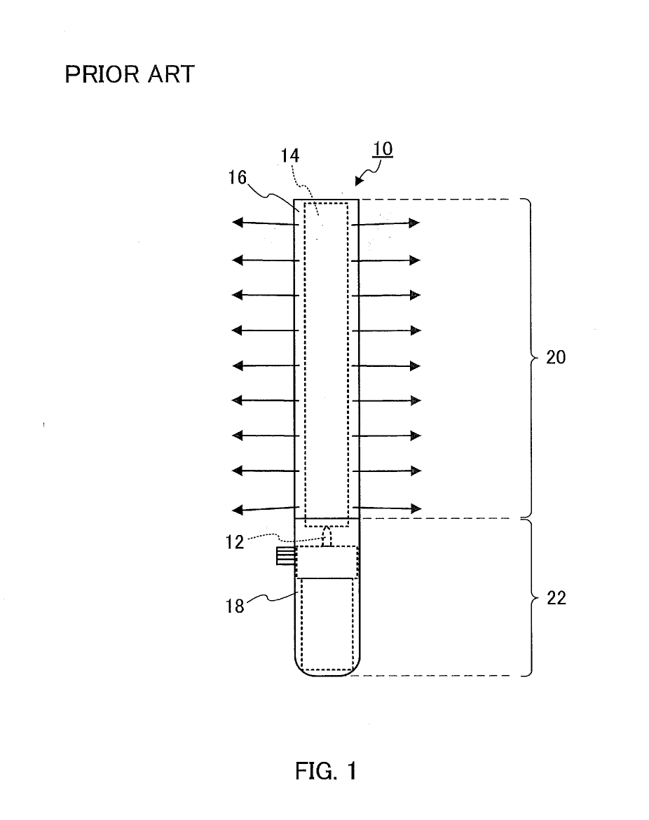

FIG. 2 is a perspective view of an illumination device of embodiment 1;

FIG. 3A is a plan view of the illumination device of embodiment 1, and FIG. 3B is a side view of the illumination device of embodiment 1;

FIG. 4 is a sectional view taken along line A-A and line B-B of FIG. 3B.

FIG. 5 is a partially enlarged sectional view of the part shown by the broken line in FIG. 4;

FIGS. 6A and 6B are schematic views illustrating light paths in the part shown by the broken line in FIG. 4;

FIG. 7 is a schematic view for describing a method for determining light distribution characteristics;

FIG. 8 is a graph of the light distribution characteristics of the illumination device of embodiment 1;

FIG. 9 is a sectional view of an illumination device of embodiment 2;

FIG. 10 is a schematic view illustrating light paths in the part shown by the broken line in FIG. 9;

FIG. 11 is a graph of the light distribution characteristics of the illumination device of embodiment 2;

FIG. 12A is a sectional view of an illumination device of embodiment 3, and FIG. 12B is a partially enlarged sectional view of the part shown by the broken line in FIG. 12A;

FIG. 13A is a plan view of an illumination device of embodiment 4, and FIG. 13B is a side view of the illumination device of embodiment 4; and

FIGS. 14A to 14D are sectional views of the illumination device of embodiment 4.

### DESCRIPTION OF EMBODIMENTS

Hereinafter, embodiments of the present invention will be described in detail with reference to the accompanying drawings. The following description explains an illumination device which can be used in place of fluorescent tubes, as a typical example of the illumination device of the embodiments of the present invention.

### Embodiment 1

### Configuration of Illumination Device

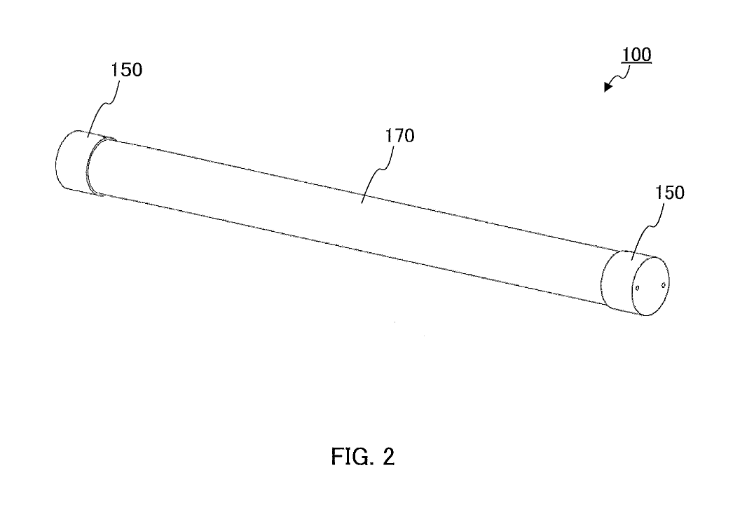

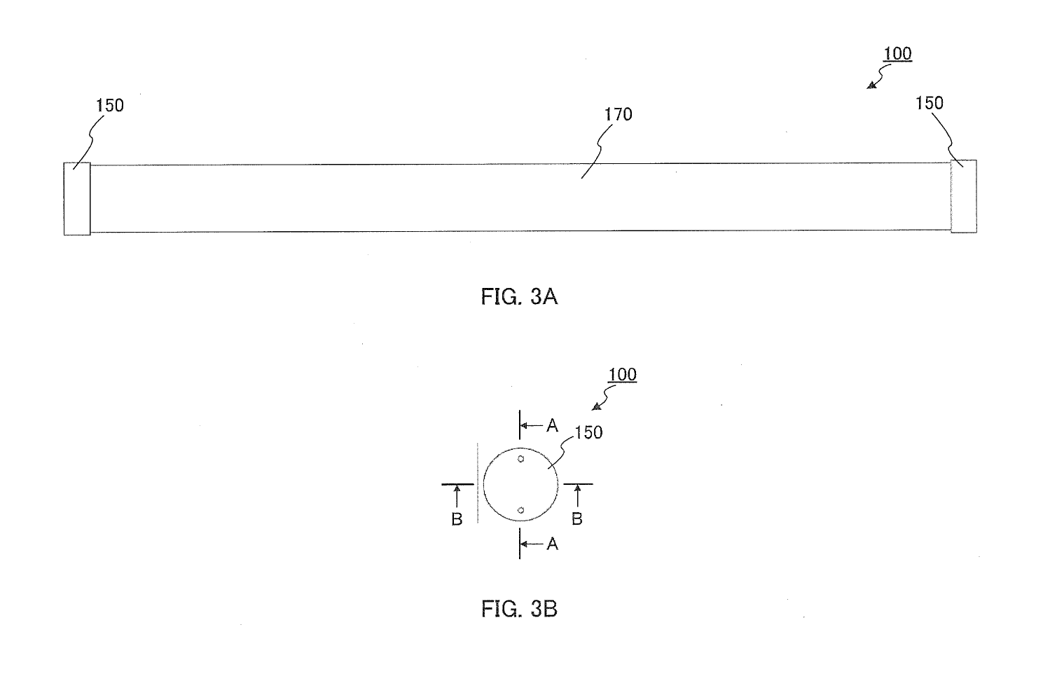

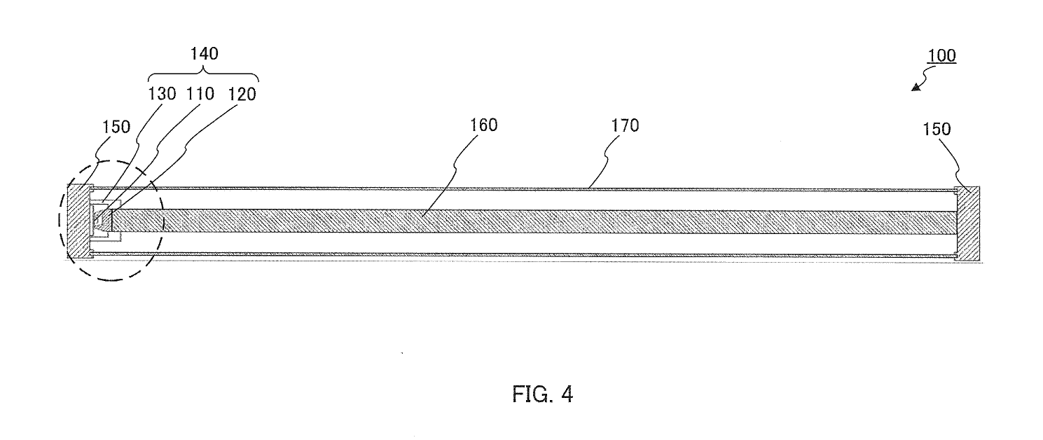

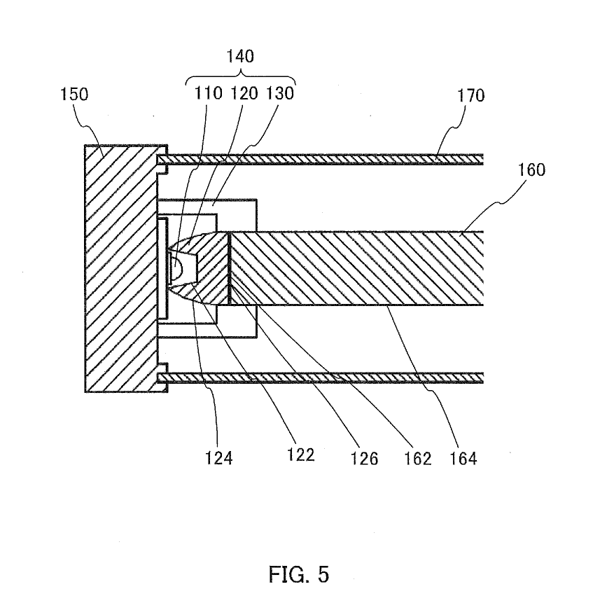

FIG. 2 is a perspective view of illumination device 100 of embodiment 1 of the present invention. FIG. 3A is a plan view of illumination device 100, and FIG. 3B is a side view of illumination device 100. FIG. 4 is a sectional view taken along line A-A and line B-B of FIG. 3B. FIG. 5 is a partially enlarged sectional view of the region shown by the broken line in FIG. 4.

As illustrated in FIG. 2 to FIG. 5, illumination device 100 includes light emitting element 110, light flux controlling member 120, holder 130, heat sink 150, light guiding rod 160 and cover 170. Light emitting element 110, light flux controlling member 120 and holder 130 function as light source unit 140.

Light emitting element 110 is a light source of illumination device 100 and is disposed on a substrate mounted on heat sink 150 (see FIG. 5). Light emitting element 110 is composed of, for example, a light-emitting diode (LED) such as a white light-emitting diode. The substrate is made of, for example, a metal having a high thermal conductivity such as aluminum and copper.

Light flux controlling member 120 controls the travelling direction of light emitted from light emitting element 110. That is, light flux controlling member 120 controls the distribution (diffusion) of the light emitted from light emitting element 110. Light flux controlling member 120 is disposed in such a manner that its central axis matches the optical axis of light emitting element 110 (see FIG. 5). As illustrated in FIG. 5, light flux controlling member 120 includes incidence surface 122 on which light emitted from emitting element 110 is incident, total reflection surface 124 that totally reflects part of the light incident on incidence surface 122, and emission surface 126 that emits part of the light incident on incidence surface 122 and the light reflected by total reflection surface 124. Therefore, most of the light emitted from emitting element 110 enters light flux controlling member 120 from incidence surface 122, and is emitted out of light flux controlling member 120 from emission surface 126.

Incidence surface 122 is an internal surface of a recess formed on the bottom side of light flux controlling member 120. Incidence surface 122 is so formed as to face light emitting element 110 and to intersect with the central axis of light flux controlling member 120. Incidence surface 122 is a rotationally symmetrical surface symmetrical about the central axis of light flux controlling member 120.

Total reflection surface 124 is a surface which extends from the outer edge of the bottom of light flux controlling member 120 to the outer edge of emission surface 126, and reflects the light incident on incidence surface 122 to emission surface 126. Total reflection surface 124 is a rotationally symmetrical surface that is so formed as to surround the central axis of light flux controlling member 120. The diameter of total reflection surface 124 gradually increases from incidence surface 122 side (bottom side) toward emission surface 126 side. The generatrix of total reflection surface 124 is an arc-like curve protruding outward (away from the central axis) (see FIG. 5).

Emission surface 126 is located on the side opposite to incidence surface 122 (bottom) in light flux controlling member 120, and is so formed as to intersect with the central axis of light flux controlling member 120. Emission surface 126 is a circular plane centered at the central axis of light flux controlling member 120. Emission surface 126 has a diameter substantially the same as that of end surface 162 of light guiding rod 160.

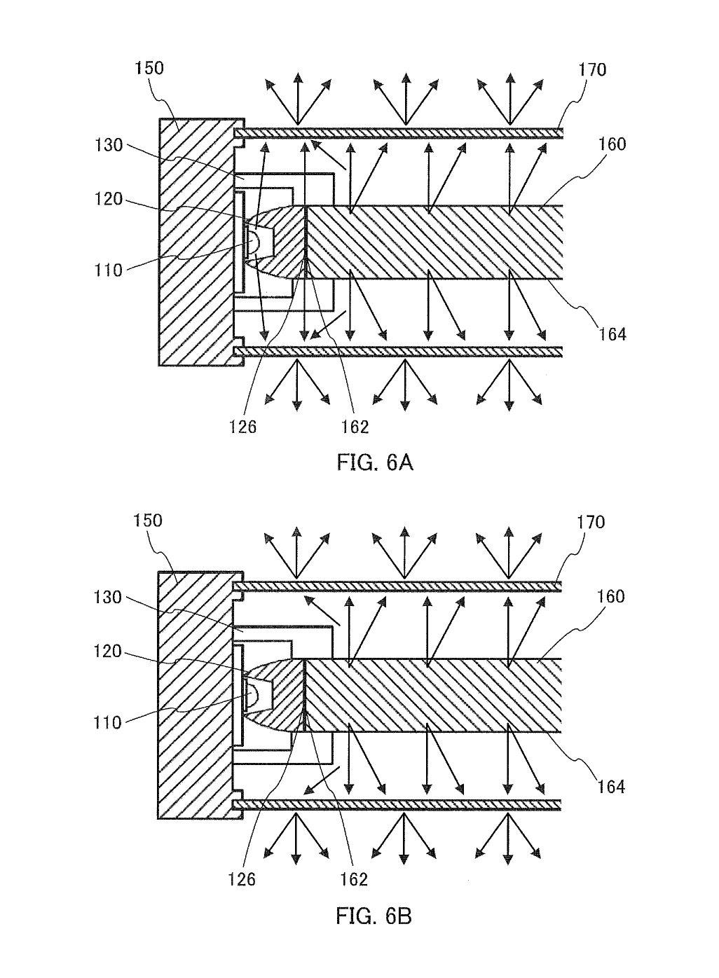

As described above, while the light having entered light flux controlling member 120 is basically output from emission surface 126, part of the light having entered light flux controlling member 120 may be output from the side surface of light flux controlling member 120 (see FIG. 6A). Such a configuration can actively make up the shortage of the light around light source unit 140. Part of the light having entered light flux controlling member 120 can be output from the side surface of light flux controlling member 120 by, for example, providing a cutout to a side part of light flux controlling member 120, roughening part of a side surface of light flux controlling member 120, or forming part of the side surface of light flux controlling member 120 as a refracting surface instead of the total reflection surface.

Light flux controlling member 120 is formed by integral molding. The material of light flux controlling member 120 is not particularly limited as long as light having the desired wavelengths can be transmitted through light flux controlling member 120. Examples of the material of light flux controlling member 120 include light transmissive resins such as polymethylmethacrylate (PMMA), polycarbonate (PC), and epoxy resin (EP); and glass.

Holder 130 surrounds light emitting element 110 and light flux controlling member 120, and sets the position of light flux controlling member 120 in such a manner that the central axis of light flux controlling member 120 matches the optical axis of light emitting element 110. The material of holder 130 is not particularly limited. Examples of the material of holder 130 include: resins such as polymethylmethacrylate (PMMA), polycarbonate (PC), and epoxy resin (EP); glass; and a metal such as aluminum. As described later, holder 130 may have light transmissivity, or light reflectivity. Holder 130 having light transmissivity can be manufactured by using a light transmissive material (a transparent resin or glass). In addition, a light diffusing property can be provided to light transmissive holder 130 by adding a diffusing member such as beads in the light transmissive material, or by performing a light expansion treatment (for example, roughening treatment) on the internal surface or external surface of manufactured holder 130 manufactured by using light transmissive materials. On the other hand, holder 130 having light reflectivity can be manufactured by using a light reflective material (white resin or glass, or metal). It is also possible to paint the surface of holder 130 manufactured by using various kinds of materials, with a light reflective coating material (for example, white paint).

Light source unit 140 is disposed in such a manner that light having passed through light flux controlling member 120 is incident on end surface 162 of light guiding rod 160 described later. To be more specific, light source unit 140 is disposed in such a manner that emission surface 126 of light flux controlling member 120 faces end surface 162 of light guiding rod 160 (see FIG. 5). Thus, most of the light emitted from emission surface 126 of light emitting element 110 enters light guiding rod 160 from end surface 162. In view of efficiently leading light to enter light guiding rod 160, emission surface 126 and end surface 162 are preferably in contact with each other. Holder 130 also has a function to set the position of light guiding rod 160 in such a manner that end surface 162 of light guiding rod 160 faces emission surface 126 of light flux controlling member 120.

Heat sinks 150 are disposed on the both ends of illumination device 100, and have a function to cool light emitting element 110. In addition, in heat sink 150, a circuit that connects light emitting element 110 with an external power source circuit is formed. Heat sink 150 is manufactured by using, for example, a metal having high thermal conductivity such as aluminum and copper.

Light guiding rod 160 is a light transmissive light guiding member having a columnar shape. Light guiding rod 160 allows the light whose light distribution has been controlled by light flux controlling member 120 to enter thereto from end surface 162. That is, end surface 162 of light guiding rod 160 functions as an incidence surface. The light having entered light guiding rod 160 travels in light guiding rod 160 by a predetermined distance, and is then output from outer peripheral surface (side surface) 164 of light guiding rod 160. That is, outer peripheral surface 164 of light guiding rod 160 functions as an emission surface.

While light guiding rod 160 has a round columnar shape in the present embodiment, the shape of light guiding rod 160 is not particularly limited as long as light guiding rod 160 has a columnar shape which includes end surface 162 and outer peripheral surface 164. For example, light guiding rod 160 may have a rectangular columnar shape. In addition, the length and thickness of light guiding rod 160 is appropriately set in accordance with the usage, the strength of light emitted from light emitting element 110, and the like.

Light guiding rod 160 is formed by, for example, injection molding, extrusion molding, casting molding, and the like. The material of light guiding rod 160 is not particularly limited as long as light having the desired wavelengths can pass through light guiding rod 160. Examples of the material of light guiding rod 160 include light transmissive resins such as polymethylmethacrylate (PMMA), polycarbonate (PC), and epoxy resin (EP); and glass. In addition, a diffusing member such as beads may be dispersed in the above-mentioned light transmissive resins or glass. By dispersing a diffusing member in light guiding rod 160 at a suitable density, a forward diffusing property can be provided to light guiding rod 160 (see FIG. 6A and FIG. 6B). In addition, a light expansion treatment (for example, roughening treatment) may be performed on outer peripheral surface 164 of light guiding rod 160.

By cover 170, the light emitted from outer peripheral surface 164 of light guiding rod 160 is transmitted to the outside while being diffused. In addition, by cover 170, the light which has not entered light guiding rod 160 but has reached cover 170 is transmitted to the outside while being diffused (see FIG. 6A). Cover 170 is disposed in such a manner as to cover at least part of light source unit 140 and light guiding rod 160, or more correctly, to cover at least part of a side surface of light source unit 140 and outer peripheral surface 164 of light guiding rod 160, with an air layer interposed between cover 170 and at least part of light source unit 140 and between cover 170 and light guiding rod 160. Thus, the air layer exists not only between light guiding rod 160 and cover 170, but also between light source unit 140 and cover 170 (see FIG. 5). The thickness of the air layer is not particularly limited as long as the light emitted from outer peripheral surface 164 of light guiding rod 160 can travel between light source unit 140 and cover 170. The exterior surface of cover 170 corresponding to at least part of light source unit 140 and light guiding rod 160 serves as an effective light emission region. The term “effective light emission region” refers to a light emission region that satisfies the quality required for illumination device 100.

The shape of cover 170 is not particularly limited as long as it can cover light source unit 140 and light guiding rod 160 with the air layer therebetween. For example, while cover 170 has a cylindrical form in the present embodiment, cover 170 may has a substantially cylindrical form as described in embodiment 4.

The material of cover 170 is not particularly limited as long as the material has light transmissivity. Examples of the material of cover 170 include light transmissive resins such as polymethylmethacrylate (PMMA), polycarbonate (PC), polystyrene (PS), and styrene methyl methacrylate copolymerization resin (MS). In addition, the method for providing cover 170 with a light expansion function is not particularly limited. For example, a light expansion treatment (for example, roughening treatment) may be performed on the internal surface or external surface of cover 170, or a diffusing member such as beads may be dispersed in the above-mentioned light transmissive resins.

FIGS. 6A and 6B are schematic views illustrating light paths during use, in the region shown by the broken line in FIG. 4. FIG. 6A is a schematic view of illumination device 100 in a mode where light is emitted also from the side surface of light flux controlling member 120. In this mode, holder 130 has light transmissivity. On the other hand, FIG. 6B is a schematic view of illumination device 100 in a mode where light is emitted only from emission surface 126 of light flux controlling member 120. In this mode, holder 130 has light reflectivity.

As illustrated in FIG. 6A and FIG. 6B, the light emitted from light emitting element 110 enters light flux controlling member 120. The distribution of the light having entered light flux controlling member 120 is controlled such that the light reaches light guiding rod 160 with a good balance in the range from the near end to the other end of light guiding rod 160, and then the light is emitted from emission surface 126 toward end surface 162 of light guiding rod 160. The light emitted from emission surface 126 enters light guiding rod 160. The light having entered light guiding rod 160 travels in light guiding rod 160, and then emitted from outer peripheral surface 164. As illustrated in FIG. 6A and FIG. 6B, the light emitted from outer peripheral surface 164 is transmitted through the air layer, and then reaches the internal surface of cover 170. At this time, since the air layer is provided also between light source unit 140 (holder 130) and cover 170, the light emitted from outer peripheral surface 164, the light reflected on the internal surface of cover 170 and the like reach the internal surface of cover 170 also in a region near light source unit 140 (light emitting element 110). The light having reached the internal surface of cover 170 is transmitted through cover 170 while being diffused. As a result, the light is substantially uniformly emitted from the entirety of the exterior surface of cover 170.

In the exemplary case illustrated in FIG. 6A, part of the light having entered light flux controlling member 120 is emitted from the side surfaces, not from emission surface 126, and is then transmitted through holder 130 before reaching the internal surface of cover 170. Also, part of the light emitted from emission surface 126 leaks from the location between emission surface 126 and end surface 162 toward cover 170. As illustrated in FIG. 6A, by utilizing such pieces of light, the shortage of light around light source unit 140 (light emitting element 110) can be actively made up. On the other hand, in the exemplary case illustrated in FIG. 6B, the outside surface of holder 130 has light reflectivity. Thus, light having reached the region around light source unit 140 does not enter holder 130. With this configuration, the loss of light around light source unit 140 can be prevented.

In the present embodiment, in the case where light guiding rod 160 in which a diffusing member is dispersed is used, when the density of the diffusing member is increased, the amount of forward diffusing light decreases whereas the amount of rearward diffusing light increases. In addition, in the case where light guiding rod 160 in which the surface of outer peripheral surface 164 is roughened is used, when the roughness of the surface increased, the amount of the rearward diffusing light increases. Since the rearward diffusing light tends to reach the air layer between light source unit 140 and cover 170, the shortage of light around light source unit 140 (light emitting element 110) can be further made up by increasing the amount of the rearward diffusing light. It should be noted that, since the amount of the light which reaches the opposite end portion of light guiding rod 160 (the end portion at which light source unit 140 is not disposed) decreases as the amount of the rearward diffusing light increases, the increase of the amount of the rearward diffusing light is not suitable for light guiding rod 160 in which the light guiding distance is long.

### (Evaluation Test)

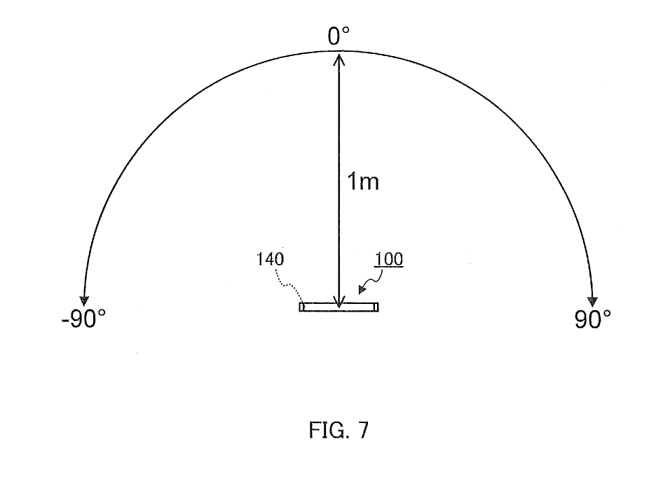

The light distribution characteristics of illumination device 100 of embodiment 1 were evaluated. FIG. 7 is a schematic view illustrating a method for determining the light distribution characteristics. As illustrated in FIG. 7, an illuminometer was disposed at a location (reference position 0°) just above (in the direction orthogonal to the longitudinal direction) the center of illumination device 100 at a distance of 1 m. The illuminance was measured in such a manner that the position of the illuminometer is changed at intervals of 2 degrees in the right-handed rotation (+θ direction) from the reference position to the point of 90 degrees, about the center of illumination device 100 as the rotational center. Likewise, the illuminance was measured in such a manner that the position of the illuminometer is changed at the intervals of 2 degrees in the left-handed rotation (−θ direction) from the reference position to the point of −90 degrees. The points of 90 degrees and −90 degrees are located on the extended line of light guiding rod 160 in the longitudinal direction. As illustrated in FIG. 7, of the two end portions of illumination device 100, light source unit 140 is disposed on the end portion on the −90 degrees side.

In this test, the light distribution characteristics of illumination device 100 including the following light transmissive holder 130, light guiding rod 160 and cover 170 were determined.

### <Holder>

Material: polycarbonate

### <Light Guiding Rod>

Length: 300 mm

Thickness: 4 mm, 8 mm or 16 mm

Material: acrylic resin (added with 1 wt % of silicone particles having a mean particle diameter of 6.8 μm)

### <Cover>

Outer diameter: 26 mm

Thickness: 1 mm

Material: acrylic resin

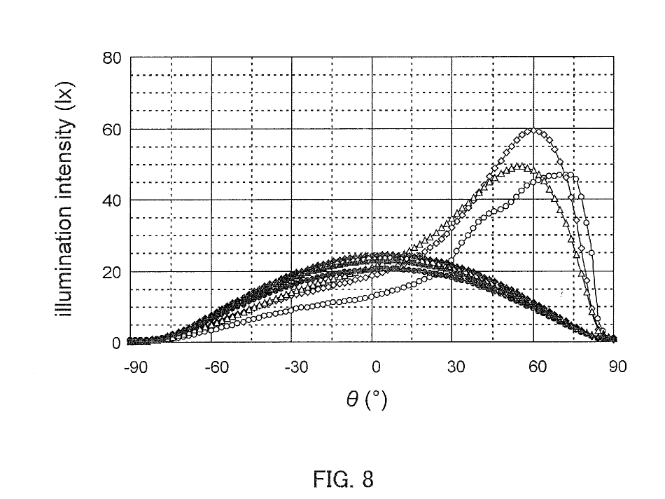

FIG. 8 is a graph of the light distribution characteristics of illumination device 100 of embodiment 1. The lines of white marks represent the light distribution characteristics of the case where cover 170 is not mounted, and the lines of black marks represent the light distribution characteristics of the case where cover 170 is mounted. Round marks (∘, •) represent the illuminance value of illumination device 100 including light guiding rod 160 having a diameter of 4 mm, quadrangular marks (⋄, ♦) represent the illuminance value of illumination device 100 including light guiding rod 160 having a diameter of 8 mm, and triangular marks (Δ, ▴) represent the illuminance value of illumination device 100 including light guiding rod 160 having a diameter of 16 mm.

In FIG. 8, the measurement results (white marks) of the state where cover 170 is not mounted show that light guiding rod 160 used in the test has a forward diffusing property (the peaks of the illuminance are at about 50 to 60 degrees). On the other hand, the measurement results (black marks) of the state where cover 170 is mounted show that well-balanced light distribution characteristics can be achieved with cover 170 (the peaks of the illuminance are at about 0 degree).

In addition, the external appearance of illumination device 100 was observed with the naked eye during the determination of the light distribution characteristics, and the entirety of cover 170 was bright, and almost no luminance unevenness was observed.

### (Effect)

Since illumination device 100 of embodiment 1 has a configuration in which the light from light emitting element 110 disposed at the end portion is guided by light guiding rod 160, the bright spot corresponding to light emitting element 110 is not seen through cover 170. In addition, since light is emitted from outer peripheral surface 164 of light guiding rod 160 in all directions, the light distribution angle is wide.

In addition, since the air layer is provided between light source unit 140 and cover 170 so that the light reaches the internal surface of cover 170 also in a region near light source unit 140 in illumination device 100 of embodiment 1, the region near light source unit 140 can be used as the effective light emission region. Further, since the distribution of the light emitted from light emitting element 110 is adjusted by light flux controlling member 120 in illumination device 100 of embodiment 1, it is possible to prevent the luminance in the region near light source unit 140 from being excessively increased, and to prevent the luminance in the region distanced from light source unit 140 from being significantly decreased.

As described above, illumination device 100 of embodiment 1 can achieve both expansion of effective light emission region and uniformization of the luminance in the effective light emission region.

### Embodiment 2

### Configuration of Illumination Device

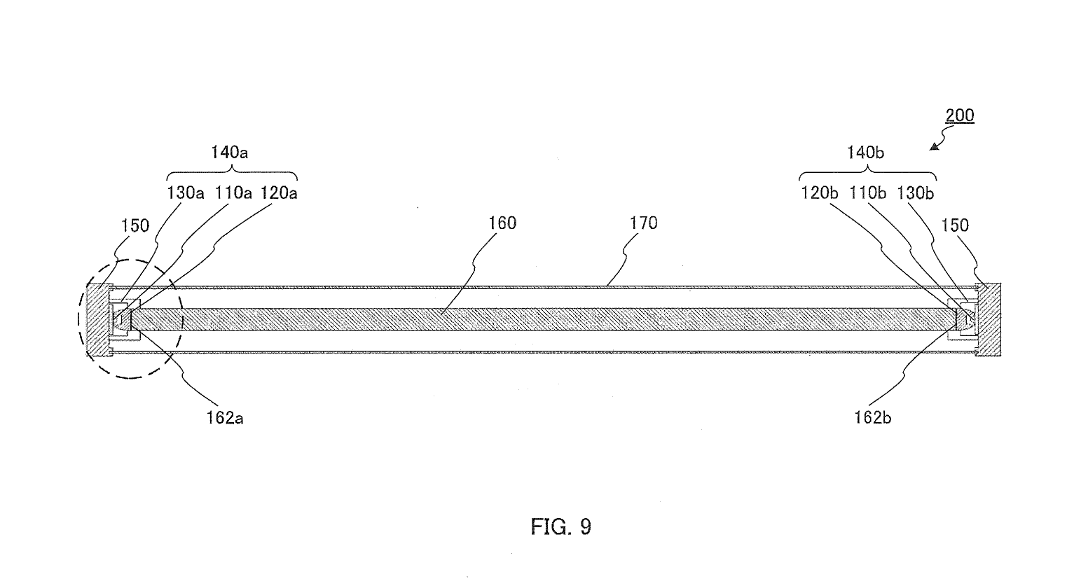

FIG. 9 is a sectional view illustrating a configuration of illumination device 200 of embodiment 2 of the present invention. Illumination device 200 of embodiment 2 is different from illumination device 100 of embodiment 1 in that light source unit 140 (first light source unit 140a and second light source unit 140b) is disposed at the both ends of light guiding rod 160. Here, the same components as those of illumination device 100 of embodiment 1 are denoted by the same reference numerals, and the descriptions thereof are omitted.

First light source unit 140a includes first light emitting element 110a, first light flux controlling member 120a and first holder 130a. Likewise, second light source unit 140b includes second light emitting element 110b, second light flux controlling member 120b and second holder 130b. First light source unit 140a is disposed in such a manner that it faces first end surface 162a of light guiding rod 160, and second light source unit 140b is disposed in such a manner that it faces second end surface 162b of light guiding rod 160. To be more specific, first light source unit 140a is disposed in such a manner that the emission surface of first light flux controlling member 120a faces first end surface 162a of light guiding rod 160. In addition, second light source unit 140b is disposed in such a manner that the emission surface of second light flux controlling member 120b faces second end surface 162b of light guiding rod 160.

Light guiding rod 160 is the same as light guiding rod 160 of illumination device 100 of embodiment 1. In view of effectively using a pair of light source units 140 (first light source unit 140a and second light source unit 140b) disposed at the both ends of light guiding rod 160, light guiding rod 160 preferably has a forward diffusing property.

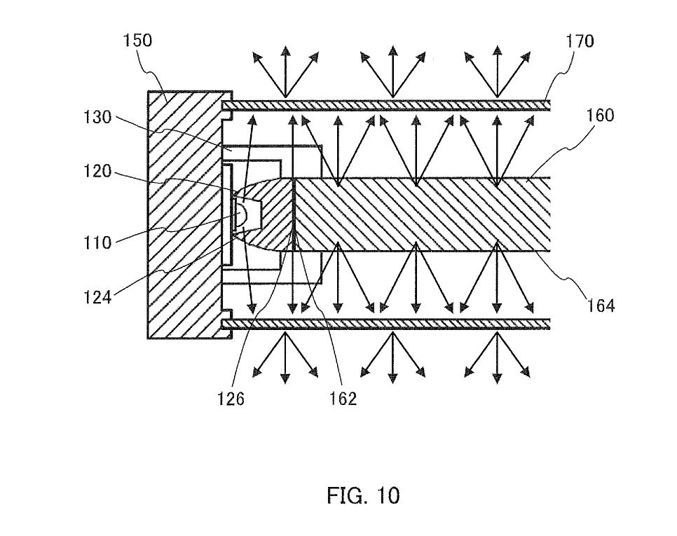

FIG. 10 is a schematic view illustrating light paths during use, in the region shown by the broken line in FIG. 9. In the mode illustrated in FIG. 10, holder 130 has light transmissivity. In addition, light guiding rod 160 has a forward diffusing property.

As illustrated in FIG. 10, in illumination device 200 of embodiment 2, not only the light emitted from first light source unit 140a, but also the light emitted from second light source unit 140b is emitted from outer peripheral surface 164 of light guiding rod 160. At this time, part of the forward diffusing light derived from the light emitted from first light source unit 140a travels between second light source unit 140b (holder 130b) and cover 170. In addition, part of the forward diffusing light derived from the light emitted from second light source unit 140b travels between first light source unit 140a (holder 130a) and cover 170. As a result, in comparison with the case of illumination device 100 of embodiment 1, the amount of light which reaches the internal surface of cover 170 in a region near light source unit 140 is large in illumination device 200 of embodiment 2.

### (Evaluation Test)

In the above-described procedure, the light distribution characteristics of illumination device 200 of embodiment 2 were evaluated (see FIG. 7). In this test, the light distribution characteristics of illumination device 200 including the following light transmissive first holder 130a, second holder 130b, light guiding rod 160 and cover 170 were determined.

### <Holder>

Material: polycarbonate

### <Light Guiding Rod>

Length: 300 mm

Thickness: 4 mm, 8 mm or 16 mm

Material: acrylic resin (added with 1 wt % of silicone particles having a mean particle diameter of 6.8 μm)

### <Cover>

Outer diameter: 26 mm

Thickness: 1 mm

Material: acrylic resin

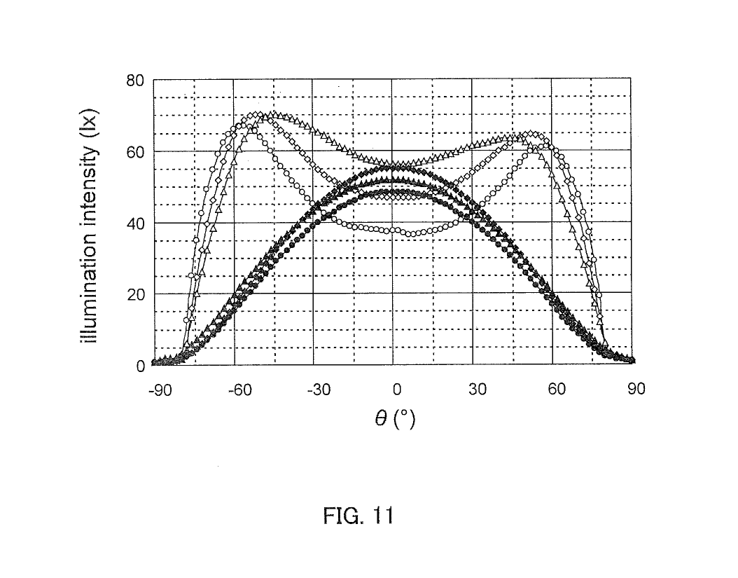

FIG. 11 is a graph of the light distribution characteristics of illumination device 200 of embodiment 2. The lines of white marks represent the light distribution characteristics of the case where cover 170 is not mounted, and the lines of black marks represent the light distribution characteristics of the case where cover 170 is mounted. Round marks (∘, •) represent the illuminance value of illumination device 100 including light guiding rod 160 having a diameter of 4 mm, quadrangular marks (⋄, ♦) represent the illuminance value of illumination device 200 including light guiding rod 160 having a diameter of 8 mm, and triangular marks (Δ, ▴) represent the illuminance value of illumination device 200 including light guiding rod 160 having a diameter of 16 mm.

As illustrated in the graph, since light source unit 140 (first light source unit 140a and second light source unit 140b) is disposed at the both ends of light guiding rod 160 in illumination device 200 of embodiment 2, the peaks of the illuminance were at two points, at about 50 to 60 degrees and about −50 to −60 degrees when cover 170 is not mounted (see white marks). On the other hand, the peaks of the illuminance were at about 0 degree when cover 170 is mounted (see black marks). Comparing the graphs of FIG. 8 and FIG. 11, in the case where illumination device 200 of embodiment 2 is used, the illuminance is more than double in comparison with the case where illumination device 100 of embodiment 1 is used.

### (Effect)

Since the amount of the light which reaches a region around light source unit 140 is large, illumination device 200 of embodiment 2 can achieve an effect that the luminance unevenness in the effective light emission region can be further reduced, in addition to the effect of illumination device 100 of embodiment 1.

### Embodiment 3

### Configuration of Illumination Device

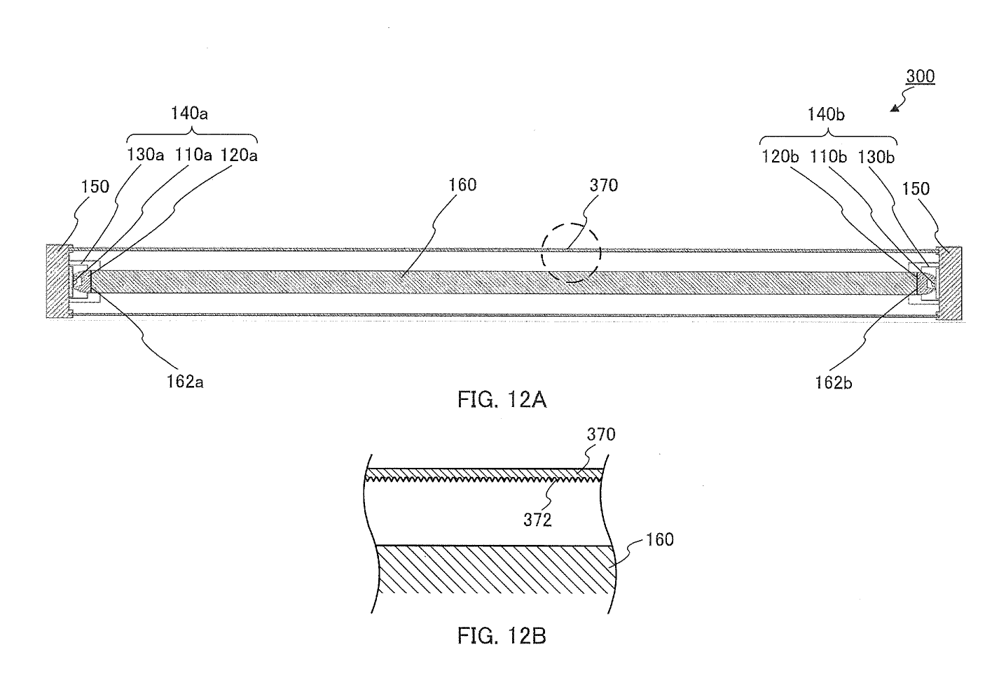

FIG. 12A is a sectional view illustrating a configuration of illumination device 300 of embodiment 3 of the present invention. FIG. 12B is a partially enlarged sectional view of the region shown by the broken line in FIG. 12A. Illumination device 300 of embodiment 3 is different from illumination device 200 of embodiment 2 in that a plurality of prisms 372 are formed on the internal surface of cover 370. Here, the same components as those of illumination device 200 of embodiment 2 are denoted by the same reference numerals, and the descriptions thereof are omitted.

Cover 370 has a form which is obtained by rounding a prism sheet having a plurality of prisms 372 formed in parallel to one another on one surface thereof, with prisms 372 facing the inside. The form in cross-section orthogonal to the ridgeline of each prism 372 is a substantially triangular shape. In addition, the circle formed by the ridgeline of each prism 372 is orthogonal to the center line of light guiding rod 160. Prisms 372 change the travelling directions of the forward diffusing light derived from the light from first light source unit 140a and the forward diffusing light derived from the light from second light source unit 140b, thereby achieving an efficient output of the forward diffusing light.

### (Effect)

Since the forward diffusing light emitted from light guiding rod 160 can be efficiently output, illumination device 300 of embodiment 3 can achieve an effect that the luminance can be further increased, in addition to the effect of illumination device 200 of embodiment 2.

### Embodiment 4

### Configuration of Illumination Device

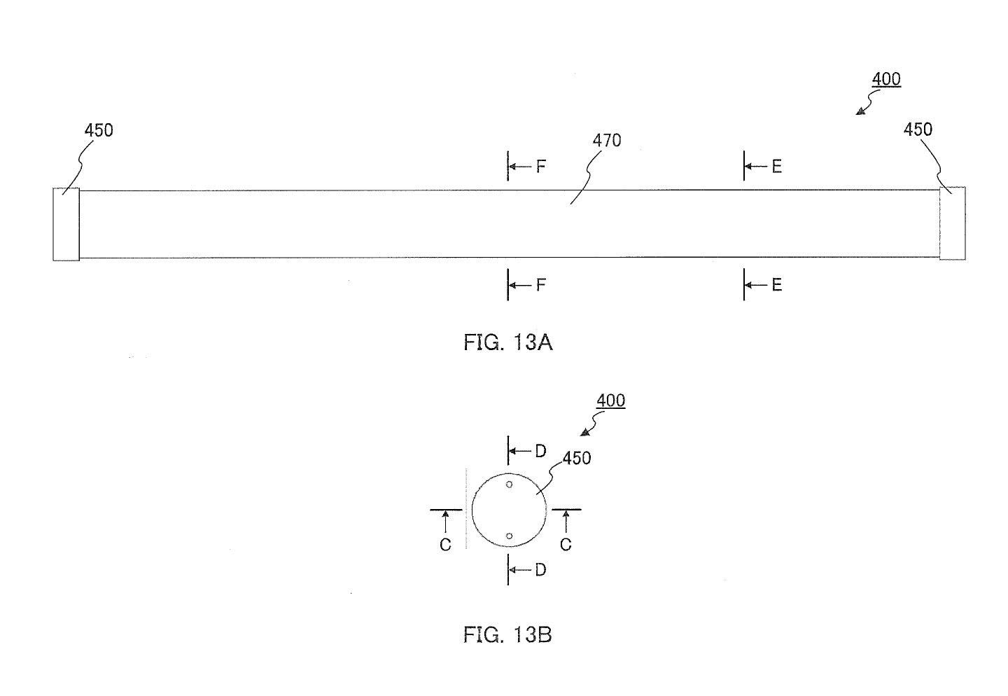

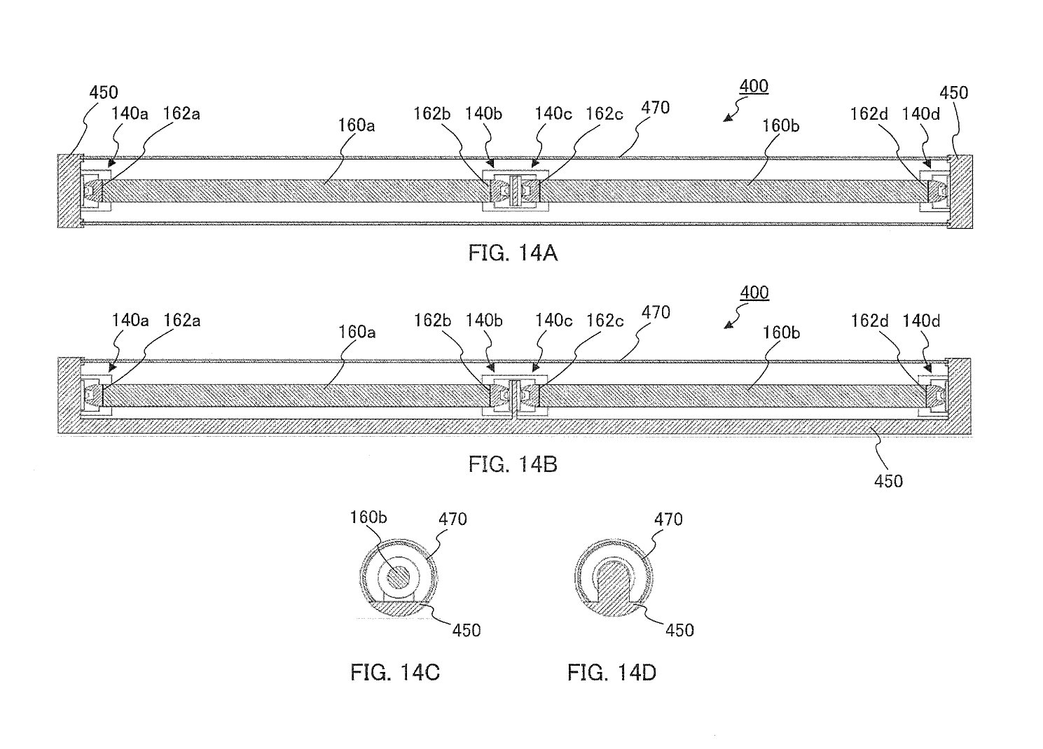

FIG. 13A is a plan view of illumination device 400 of embodiment 4 of the present invention, FIG. 13B is a side view of illumination device 400. FIG. 14A is a sectional view taken along line C-C illustrated in FIG. 13B, FIG. 14B is a sectional view taken along line D-D illustrated in FIG. 13B, FIG. 14C is a sectional view taken along line E-E illustrated in FIG. 13A, and FIG. 14D is a sectional view taken along line F-F illustrated in FIG. 13A.

Illumination device 400 of embodiment 4 is different from illumination device 200 of embodiment 2 in that illumination device 400 includes two light guiding rods 160 (first light guiding rod 160a and second light guiding rod 160b), and that light source units 140 (first light source unit 140a and second light source unit 140b, or third light source unit 140c and fourth light source unit 140d) are disposed at the both ends of each of light guiding rods 160a and 160b. Here, the same component as those of illumination device 200 of embodiment 2 are denoted by the same reference numerals, and the descriptions thereof are omitted.

As illustrated in FIG. 13A to FIG. 14D, illumination device 400 includes four light source units 140 (first light source unit 140a, second light source unit 140b, third light source unit 140c and fourth light source unit 140d), heat sink 450, two light guiding rod 160 (first light guiding rod 160a and second light guiding rod 160b) and cover 470. Each light source unit 140 includes light emitting element 110, light flux controlling member 120 and holder 130.

Each light source unit 140 is disposed in such a manner that it faces end surface 162 of light guiding rod 160. To be more specific, first light source unit 140a is disposed in such a manner that it faces first end surface 162a of first light guiding rod 160a, and second light source unit 140b is disposed in such a manner that it faces first end surface 162b of first light guiding rod 160a. First light source unit 140a, second light source unit 140b and first light guiding rod 160a compose a first illumination unit. Likewise, third light source unit 140c is disposed in such a manner that it faces first end surface 162c of second light guiding rod 160b, and fourth light source unit 140d is disposed in such a manner that it faces second end surface 162d of second light guiding rod 160b. Third light source unit 140c, fourth light source unit 140d and second light guiding rod 160b compose a second illumination unit.

Heat sink 450 is disposed at the both end portions, center portion and bottom portion of illumination device 400, and has a function to cool light emitting element 110 of each light source unit 140. In addition, heat sink 450 also has a function to arrange, in series, the first illumination unit (first light source unit 140a, second light source unit 140b and first light guiding rod 160a) and the second illumination unit (third light source unit 140c, fourth light source unit 140d and second light guiding rod 160b).

By cover 470, the light emitted from the outer peripheral surfaces of first light guiding rod 160a and second light guiding rod 160b is transmitted to the outside while being diffused. Cover 470 is disposed in such a manner as to cover the first illumination unit (first light source unit 140a, second light source unit 140b and first light guiding rod 160a) and the second illumination unit (third light source unit 140c, fourth light source unit 140d and second light guiding rod 160b), with an air layer interposed between cover 470 and the first illumination unit and between cover 470 and the second illumination unit. In the present embodiment, cover 470 has a substantially cylindrical form (the form which is obtained by cutting out part of a cylindrical form).

### (Effect)

By additionally providing the illumination unit (light guiding rod 160 and a pair of light source units 140 disposed at the both ends of light guiding rod 160), illumination device 400 of embodiment 4 can achieve an effect that the length can be increased while maintaining the luminance, in addition to the effect of illumination device 200 of embodiment 2.

### [Modification]

It is to be noted that, while light source unit 140 has holder 130 in the above-mentioned embodiments, holder 130 is not an essential component of light source unit 140. For example, the position of light flux controlling member 120 may be set by utilizing a leg part formed in light flux controlling member 120.

In addition, while a condenser lens is used as light flux controlling member 120 in the above-mentioned embodiments, light flux controlling member 120 may not be the condenser lens. For example, light flux controlling member 120 may be a reflector that guides the light from light emitting element 110 to end surface 162 of light guiding rod 160.

In addition, while light flux controlling member 120, holder 130 and light guiding rod 160 are separately formed the above-mentioned embodiments, these components may be integrally formed. For example, light flux controlling member 120 and holder 130 may be integrated, or holder 130 and light guiding rod 160 may be integrated. Alternatively, light flux controlling member 120, holder 130 and light guiding rod 160 may be integrated.

In addition, the light guiding member included in the illumination device of the embodiments of the present invention is not limited to the round columnar light guiding rod 160 described in the above-mentioned embodiments. For example, the light guiding member may have a substantially round columnar shape, a plate-shape, an annular shape, or the like.

### INDUSTRIAL APPLICABILITY

The illumination device of the embodiments of the present invention can be used in place of fluorescent tubes, and is therefore widely applicable to various kinds of illumination devices.

This application is entitled to and claims the benefit of Japanese Patent Application No. 2012-008902 filed on Jan. 19, 2012, the disclosure of which including the specification, drawings and abstract is incorporated herein by reference in its entirety.

### REFERENCE SIGNS LIST

10 Illumination device
12 LED
14 Optical member
16 Cover
18 Handle part
20 Effective light emission region
22 Non-light emission region
100, 200, 300, 400 Illumination device
110 Light emitting element
120 Light flux controlling member
122 Incidence surface
124 Total reflection surface
126 Emission surface
130 Holder
140 Light source unit
150, 450 Heat sink
160 Light guiding rod
162 End surface
164 Outer peripheral surface
170, 370, 470 Cover
372 Prism

1. An illumination device comprising:
a light guiding member;
a light source unit including a light emitting element and a light flux controlling member that controls a distribution of light emitted from the light emitting element, the light source unit being disposed in such a manner that light passed through the light flux controlling member is incident on an end surface of the light guiding member; and
a cover disposed in such a manner as to cover at least part of the light source unit and the light guiding member, with an air layer interposed between the cover and at least part of the light source unit and between the cover and the light guiding member, wherein
an exterior surface of the cover corresponding to at least part of the light source unit and the light guiding member serves as a light emission region.

2. The illumination device according to claim 1, wherein
the light source unit includes a holder configured to set a position of the light flux controlling member with respect to the light emitting element, and
part of light emitted from the light emitting element does not enter the light guiding member, but is transmitted through the holder and reaches the cover.

3. The illumination device according to claim 1, wherein
the light source unit includes a holder configured to surround the light emitting element and the light flux controlling member, and to set a position of the light flux controlling member with respect to the light emitting element, and
the holder has light reflectivity.

4. The illumination device according to claim 1, wherein
the illumination device comprises a plurality of the light source units including a first light source unit and a second light source unit,
the first light source unit is disposed in such a manner as to face a first end surface of the light guiding member, and
the second light source unit is disposed in such a manner as to face a second end surface of the light guiding member.

5. The illumination device according to claim 1, wherein the light guiding member has a forward diffusing property.

6. The illumination device according to claim 4, wherein a plurality of prisms are formed on an internal surface of the cover.

7. The illumination device according to claim 2, wherein the light guiding member has a forward diffusing property.

8. The illumination device according to claim 3, wherein the light guiding member has a forward diffusing property.

9. The illumination device according to claim 4, wherein the light guiding member has a forward diffusing property.
